(19) United States
(12) Patent Application Publication
(10) Pub. No.: US 2010/0247983 A1
(43) Pub. Date: Sep. 30, 2010

(54) DEVICE FOR DEGASSING THE BATTERY OF AN AUTOMOBILE

(75) Inventor: Stephane Trentin, Viry-Chatillon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/681,459

(22) PCT Filed: Sep. 12, 2008
(86) PCT No.: PCT/FR08/51638

§ 371 Date: Jun. 15, 2010

(30) Foreign Application Priority Data
Oct. 2, 2007 (FR) 0757996

(51) Int. Cl. H01M 2/12; B23P 17/04

(52) U.S. Cl. 429/53; 29/592

(57) ABSTRACT

The invention relates to a device for degassing the battery (1) of an automobile, that comprises a degassing pipe (4) having a first end which is provided in the upper portion of the battery outside the latter and is connected to the inside of the battery, while the second end is provided in the vicinity of the lower portion of the battery outside the latter and is connected to an opening giving into a discharge space. According to the invention, said second end is connected to said discharge space through a check valve that only allows the flow from said first end to the discharge space.

The invention relates to a device for degassing a battery of a motor vehicle.

It relates more specifically to a battery positioned under the body shell of the vehicle. Specifically, in order to reduce the size of the space set aside for the engine, the battery may be positioned under the vehicle body shell, for example under the driver's seat.

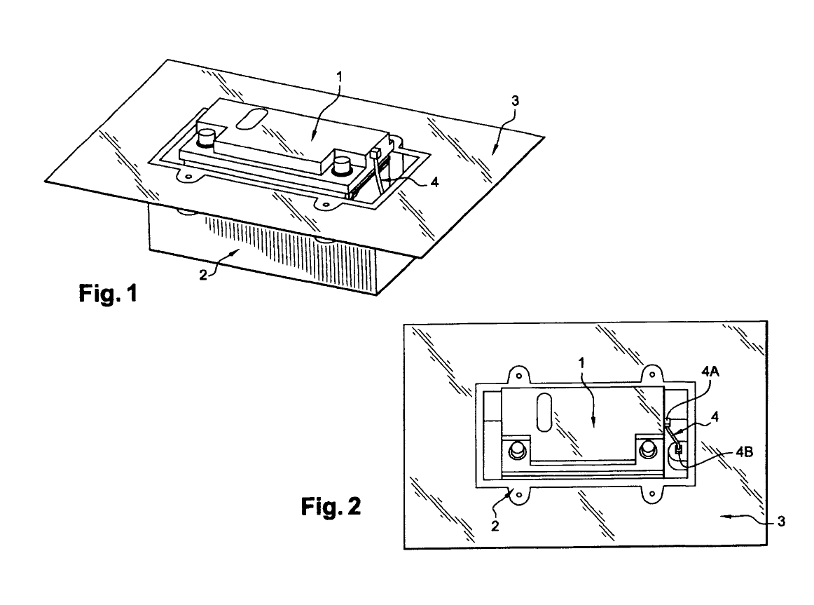

FIG. 1 depicts such a known battery.

The battery 1 is then placed in a tray 2 fixed to the floor 3 of the vehicle and under the latter. It is equipped with a degassing pipe 4 connected to the top part of the battery and intended to discharge liquid or gaseous acid in the event of overheating. The free end of this pipe is fixed into an orifice arranged in the bottom of the tray 2, to discharge the droplets of acid or acidic gas under the vehicle.

This type of device presents the following technical problem.

Once the tray has been arranged, the discharge orifice is positioned at a level below floor level. Now, given the so-called fording constraints, namely the ability of the vehicle to drive in places where a certain depth of water is present, a quantity of water may, when driving through such a location, happen to enter the discharge orifice and get into the battery, which is highly detrimental to the correct operation thereof.

The invention solves this problem and, in order to do so, proposes a device for degassing a battery of a motor vehicle, comprising a degassing pipe of which a first end, positioned at the top part of the battery and externally thereto, is connected to the inside of the battery and of which the second end, positioned near the bottom part of the battery and externally thereto, is connected to an orifice opening into a discharge space, characterized said second end is connected to said discharge space via a nonreturn valve, allowing flow only from said first end toward the discharge space.

According to a preferred embodiment of the invention, said nonreturn valve consists of a floating element positioned in said orifice.

Said orifice advantageously has a substantially vertical longitudinal axis.

Said orifice may comprise a conical portion to which said second end of the pipe is connected, and in that said floating element is at least partially of complementary conical shape.

Said orifice may also comprise a cylindrical portion connected to said discharge space, and in that said floating element is at least partially of cylindrical shape of a diameter smaller than the diameter of said cylindrical portion.

According to a first alternative form of embodiment, said cylindrical portion may be closed by a pierced wall pierced with at least one hole, and in that said floating element comprises at least two substantially axial flanges intended to press against said pierced wall.

According to a second alternative form of embodiment, said cylindrical portion comprises at least two radial clips of a width greater than the difference in diameters of said cylindrical portion and of the floating element.

The invention also relates to a module for creating a device for degassing a battery of a motor vehicle as specified hereinabove, characterized in that said orifice and said nonreturn valve are arranged in a mounting unit.

The invention is described in greater detail hereinafter with the aid of figures which depict only some preferred embodiments of the invention.

FIG. 1, already mentioned, is a perspective view of a battery with its known degassing device.

FIG. 2 is a view from above of a battery equipped with a degassing device according to the invention.

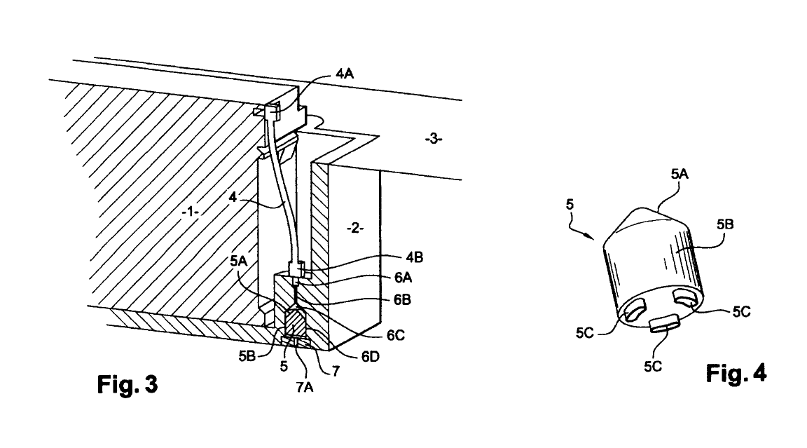

FIG. 3 is a perspective sectioned view of a battery equipped with a degassing device according to the invention, according to a first embodiment.

FIG. 4 is a perspective view of a floating valve that forms part of a battery equipped with a degassing device according to the invention, according to this first embodiment.

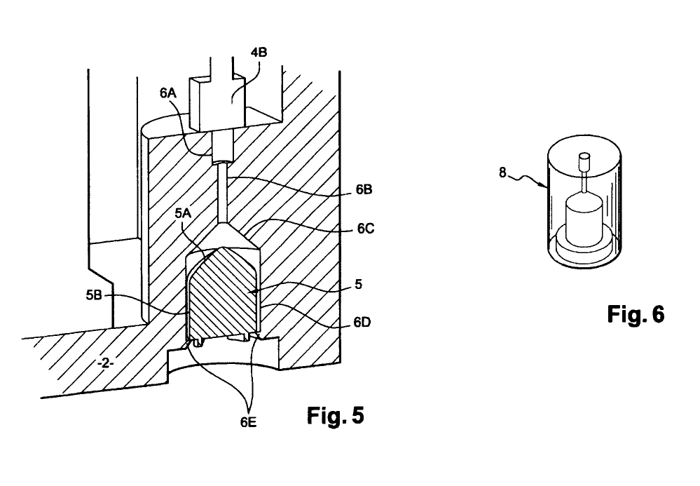

FIG. 5 is a perspective and sectioned view of a degassing device according to the invention, according to a second embodiment.

FIG. 6 is a perspective and sectioned view of a module according to the invention.

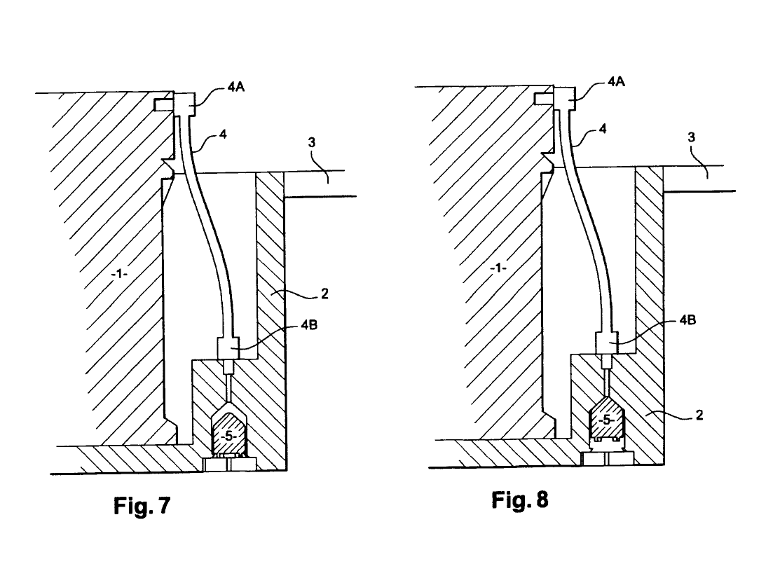

FIGS. 7 and 8 illustrate how the degassing device according to the invention works according to this first embodiment.

As illustrated in FIG. 2, the degassing pipe 4 is fixed via a clipped first end-fitting 4A secured to its first end, into a corresponding bore on the top part of the battery and externally thereto and, by a second clipped end-fitting 4B secured to its second end, into a corresponding bore in the bottom of the battery 1 tray 2, near the bottom part of the battery and externally thereto.

This second end is connected to the discharge space which in this instance is the underside of the vehicle body shell, via a nonreturn valve that allows passage only from the first end toward the discharge space, via a discharge orifice arranged in the bottom of the tray 2.

A first embodiment is depicted in FIGS. 3 and 4.

The nonreturn valve consists of a floating element 5, advantageously made of plastic, arranged in the discharge orifice the longitudinal axis of which is substantially vertical.

This orifice comprises, from the top downward, a cylindrical portion 6A of medium diameter into which the clipped coupling 4B secured to the second end of the pipe 4 is fitted, followed by a cylindrical portion 6B of smaller diameter opening onto a conical portion 6C which widens downward, itself opening onto a final cylindrical portion 6D.

The floating element has a top part 5A of complementary conical shape and a bottom part of cylindrical shape 5B of a diameter smaller than the diameter of the cylindrical portion 6D of the orifice.

The cylindrical portion 6D is closed by a pierced wall 7 pierced with at least one hole, in this instance just one central hole 7A, and the floating element 5 comprises at least two flanges, in this instance three flanges 5C, which are substantially axial and intended to bear against the pierced wall.

A second embodiment is depicted in FIG. 5.

The nonreturn valve consists of a floating element 5, advantageously made of plastic, arranged in the discharge orifice the longitudinal axis of which is substantially vertical.

This orifice comprises, from the top downward, a cylindrical portion 6A of medium diameter into which the clipped coupling 4B secured to the second end of the pipe 4 is fitted, followed by a cylindrical portion 6B of smaller diameter opening onto a conical portion 6C that widens downward itself opening onto a final cylindrical portion 6D.

The floating element has a top part 5A of complementary conical shape and a bottom part of cylindrical shape 5B of a diameter smaller than the diameter of the cylindrical portion 6D of the orifice.

The cylindrical portion 6D at its lower end comprises at least two radial clips 6E of a width greater than the difference between the diameters of this cylindrical portion and of the floating element 5.

For ease of mounting in the battery tray 2, and for easier component-part management, the orifice and valve may be incorporated into a mounting unit, advantageously cylindrical, to form a module as depicted in FIG. 6.

FIGS. 7 and 8 illustrate how the degassing device according to the invention works.

As illustrated in FIG. 7, when the vehicle is parked or driving over dry ground, the floating valve 5 presses under gravity against the pierced wall 7 according to the first alternative form of embodiment, or against the clips 6E according to the second alternative form of embodiment. If the battery overheats, the gaseous or liquid acid can be discharged from the battery via the degassing pipe 4 and the discharge orifice.

According to the first alternative form of embodiment, the acid flows between the valve shutter 5 and the wall of the orifice, then under the valve shutter 5 through the hole in the pierced wall 7.

According to the second alternative form of embodiment, the acid flows between the valve shutter 5 and the wall of the orifice, then under the valve shutter 5 between the clips 6E.

As illustrated in FIG. 8, when the vehicle is parked or driving over ground on which a certain depth of water is present, the floating valve 5 floats and comes into sealed contact via its conical part 5A against the conical portion 6C. The discharge orifice is thus closed in a sealed fashion by the nonreturn valve formed by this floating valve 5 arrangement and water cannot enter the degassing pipe 4.

1. A device for degassing a battery (1) of a motor vehicle, comprising a degassing pipe (4) of which a first end, positioned at the top part of the battery and externally thereto, is connected to the inside of the battery and of which the second end, positioned near the bottom part of the battery and externally thereto, is connected to an orifice opening into a discharge space, characterized said second end is connected to said discharge space via a nonreturn valve, allowing flow only from said first end toward the discharge space.

2. The device as claimed in the preceding claim, characterized in that said nonreturn valve consists of a floating element (5) positioned in said orifice.

3. The device as claimed in the preceding claim, characterized in that said orifice has a substantially vertical longitudinal axis.

4. The device as claimed in the preceding claim, characterized in that said orifice comprises a conical portion (6C) to which said second end of the pipe is connected, and in that said floating element (5) is at least partially of complementary conical shape (5A).

5. The device as claimed in claim 3 or 4, characterized in that said orifice comprises a cylindrical portion (6D) connected to said discharge space, and in that said floating element (5) is at least partially of cylindrical shape (5B) of a diameter smaller than the diameter of said cylindrical portion.

6. The device as claimed in the preceding claim, characterized in that said cylindrical portion (6D) is closed by a pierced wall (7) pierced with at least one hole, and in that said floating element (5) comprises at least two substantially axial flanges (5C) intended to press against said pierced wall (7).

7. The device as claimed in claim 5, characterized in that said cylindrical portion (6D) comprises at least two radial clips (6E) of a width greater than the difference in diameters of said cylindrical portion (6D) and of the floating element (5).

8. A module (8) for creating a device for degassing a battery (1) of a motor vehicle as claimed in one of the preceding claims, characterized in that it comprises said orifice and said nonreturn valve both arranged in a mounting unit.
